(19) United States
(12) Patent Application Publication
(10) Pub. No.: US 2012/0285267 A1
(43) Pub. Date: Nov. 15, 2012

(54) SAMPLE PREPARATION DEVICE

(75) Inventor: Adrian Parton, Cambridgeshire (GB)

(73) Assignee: LIFE TECHNOLOGIES CORPORATION, Carlsbad, CA (US)

(21) Appl. No.: 13/498,104

(22) PCT Filed: Sep. 20, 2010
(86) PCT No.: PCT/EP10/63805

§ 371 Date: Jul. 30, 2012

(30) Foreign Application Priority Data
Sep. 23, 2009 (GB) 0916689.3

(51) Int. Cl. G01N 1/28

(52) U.S. Cl. 73/863.23

(57) ABSTRACT

A sample preparation device comprises:

withdrawal means for withdrawing a sample from a liquid to be analysed; and

a foam filter for filtering particulate material from the sample as the sample is withdrawn, the foam filter being mounted to the withdrawal means.

### CROSS-REFERENCE TO RELATED APPLICATIONS

This application is a U.S. national phase of International Application No. PCT/EP2010/063805 filed Sep. 20, 2010 which claims priority to G.B. Application No. 0916689.3 filed Sep. 23, 2009, which disclosures are herein incorporated by reference in their entirety.

### FIELD

This invention relates to a sample preparation device for removing particulate matter from liquid samples prior to analysis, to a foam filter for use in such a device, and to a method of preparing a sample using such a device.

### BACKGROUND

In the routine analysis of liquid samples, for example food, clinical, and environmental samples, there is often a need to remove particulate debris as this would otherwise create a problem for the analysis of samples.

Typical analytes are microbiological analytes such as bacteria, viruses or fungi. Typical analytical methods include PCR, ELISA, lateral flow devices and selective agar plates with/without chromogenic indicators.

Currently analysts remove particulate matter from liquid samples using methods such as centrifugation, filtration using solid phase filters (for example filters provided inside the tip of a pipette), or simple sample bags that contain a built in filter bag to filter the sample (e.g. Stomacher™ strainer bags, in which the filter bag is spot welded to the outer bag, and the filter bag has a pore size of 0.5 mm).

U.S. Pat. No. 5,11,4679 discloses a pipette having a filter at its inlet end. The filter may be formed from fibrous polyester material or porous solid polyethylene or polypropylene.

US2010/0081209 discloses a pipette tip having an internal lower liquid permeable closure of stainless steel, porous polymer, porous glass or porous ceramic material.

Analysts face various problems with these approaches. Centrifugation and filtration using solid phase filters can reduce the efficiency of recovery of the target to be analysed i.e. the targets can be trapped by centrifugation or within the filter media used to remove the debris. Sample bags containing filter bags can be difficult to handle. In addition to the inefficiencies of these methods they are also expensive.

There is thus a need to overcome the technical and financial drawbacks of the current sample preparation devices.

### DETAILED DESCRIPTION OF EMBODIMENTS

In a first aspect, the present invention provides a sample preparation device comprising:

withdrawal means for withdrawing a sample from a liquid to be analysed; and

a foam filter for filtering particulate material from the sample as the sample is withdrawn, the foam filter being mounted to the withdrawal means.

Typically, the liquid sample is analysed and the unwanted particulate material removed from the sample is discarded.

Suitably, the withdrawal means is a pipette or a syringe, optionally provided with a tube. Suitable materials for the withdrawal means include glass and plastics. The pipette may be a standard laboratory pipette or an automatic pipette.

The withdrawal means will typically have a tip with an opening through which liquid is drawn into the withdrawal means. The pipette may include a separate pipette tip.

Preferably, the foam filter is mounted externally to the withdrawal means. More preferably, the foam filter covers the opening of the withdrawal means.

Preferably, the foam filter is removably mounted to the withdrawal means. More preferably, the foam filter can be removed by hand.

The solid foam material is sufficiently reticulated to allow liquid to flow through it. Preferred foams are formed of polyester. Foams may also be formed of polyethylene, polypropylene, polyvinylchloride or polyurethane. The foam is preferably uncompressed (except where compression is used to shape the foam filter as explained below).

Preferably, the foam filter is removably mounted to the withdrawal means via a friction fit. The foam filter should fit the withdrawal means sufficiently tightly that liquid entering the withdrawal means must pass through the foam filter. The foam is preferably a flexible foam to allow a friction fit.

The shape and size of the foam filter can be chosen to provide optimal filtration of the sample to maximise recovery of the target and removal of sample debris that may interfere with subsequent analytical methods. Typically, the maximum dimension of the foam filter will be less than 10 cm.

Suitably, the foam is shaped by stamping using a die cutting tool.

In preferred embodiments, the foam filter is cup-shaped. This allows a tip of the withdrawal means to be inserted into an opening in the foam filter. The length and diameter of the tip of the withdrawal means can be chosen to match the dimensions of the foam filter opening or vice versa.

For example, the foam filter may comprise a block of foam with a hole extending partway through the block of foam to enable a withdrawal means to be inserted. To achieve this, the foam filter may for example comprise a block of foam with a blind hole to enable a withdrawal means to be inserted, or may comprise a block of foam with a through hole having an end closed by means of compression and an opposite end open to enable a withdrawal means to be inserted. The compression can be achieved by means of hot or cold welding or by the use of a compression means such a staple or an elastic band. The compression is only intended to close the open end rather than to form a seal.

Preferably, the foam filter is formed of foam having a homogeneous pore size.

The effective pore size of the foam can be chosen to provide optimal removal of particulate debris. Preferably, the foam filter is formed of foam having a pore size in the range of 0.2 μm to 10 mm. More preferably, the pore size is in the range of 50 to 500 μm.

Concentric foam layers can be provided to provide differential filtration. Preferably, such layers are formed of foams with different pore sizes.

In a second aspect, the invention provides a foam filter for use in a sample preparation device as described above.

In a third aspect, the invention provides a method of preparing a sample from a liquid to be analysed, comprising:
withdrawing a sample from a liquid to be analysed using a sample preparation device as described above so that the foam filter filters particulate material present in the sample.

The foam filter may filter some or all particulate matter from the sample. Preferably, the sample is withdrawn through the foam filter into the withdrawal means.

Optionally, the method further comprises an initial step of mounting the foam filter to the withdrawal means and/or a further step of removing the foam filter from the withdrawal means.

The foam filter may be sterilised. For example, where the sample is for bacterial pathogen detection the foam filter is typically gamma irradiated.

The liquid is typically an aqueous liquid.

In preferred embodiments, the sample is a food, clinical or environmental sample. Examples of liquids to be analysed are liquids which are, or are derived from specimens of, foodstuffs such as meat; bodily fluids or faeces; soil. The method may further comprise an initial step of treating a specimen to form a liquid to be analysed (which may be before, after or during mounting of the foam filter to the withdrawal means). Examples include mixing or suspension of a specimen in buffer solution.

The method may further comprise steps of removing the sample from the withdrawal device and/or analysing the sample. In a preferred embodiment, the sample is dispensed from the withdrawal device without passing through the foam filter.

In further aspects, the invention relates to:

a filter that can be attached indirectly, by means of a tube, or directly to a sample withdrawing device for filtering of samples from highly particulate samples

a filter that can be attached indirectly, by means of a tube, or directly to a sample withdrawing device for filtering of samples from highly particulate samples and removed prior to analysis of the sample

a filter that is comprised of a homogenous pore size

a filter that preferably is made of open cell reticulated foam

a filter that preferably has a pore size from 0.2 μm to 10 mm

a filter that is comprised of multiple layers with varying pores sizes to allow the differential filtration of a sample

a filter that is comprised of a solid block of foam with a partial central core to enable a withdrawing device to be inserted

a filter that is comprised of a solid block of foam with a central core, with one end closed by means of compression and the other end open to enable a withdrawing device to be inserted.

The invention will be further described with reference to the illustrated preferred embodiments and the Examples.

### BRIEF DESCRIPTION OF DRAWINGS

In the drawings:

FIG. 1 shows a filter 10 (cross-section).

FIG. 2 shows a syringe 4 fitted with the filter 10 of FIG. 1 via a tube 3.

FIG. 3 shows the syringe of FIG. 2 inside a liquid sample containing particulate matter 5.

FIG. 4 shows an alternative foam filter 20 (cross-section).

FIG. 5 shows an alternative foam filter 30 with multiple foam layers: FIG. 5(a) is a perspective view and FIG. 5(b) is a cross-section.

FIG. 6 shows the results of Example 4.

### DETAILED DESCRIPTION OF DRAWINGS

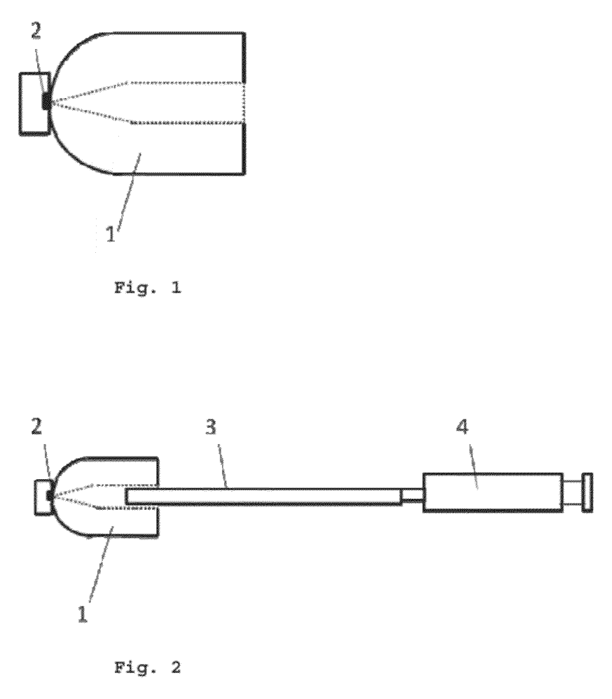

The foam filter 10 of FIG. 1 is formed by die cutting. The foam filter 10 has the form of a foam cylinder 1 with a central core removed. One end of the foam cylinder 1 is compressed by means of a staple 2 to close the cylinder. The foam filter 10 has the following dimensions: 20 mm diameter, 5 mm diameter central core, 40 mm cylinder length, with the last 10 mm sealed.

In FIG. 2 the foam filter 10 is attached to a tube 3 by pushing the open end of the filter 10 over the end of the tube 3. The tube 3 is fitted to a syringe 4.

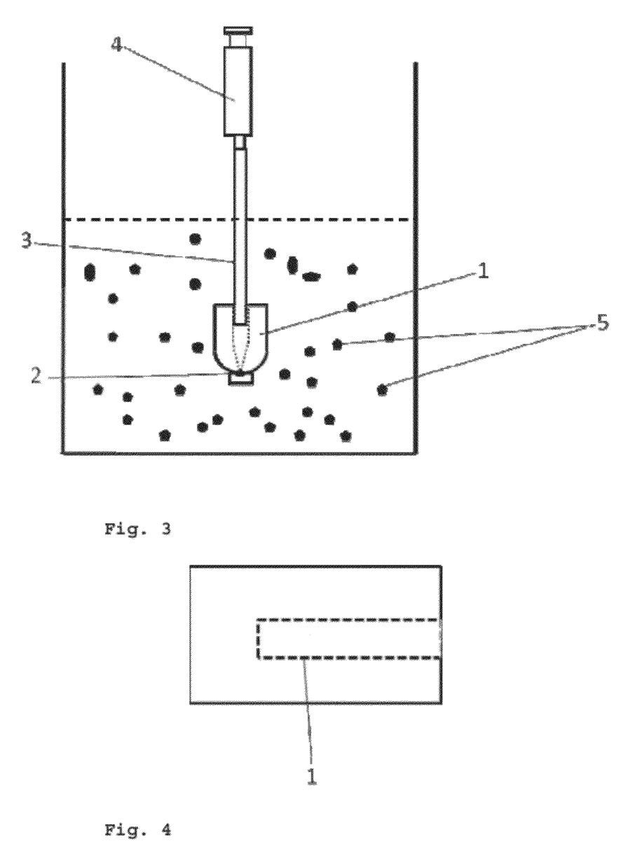

In use (FIG. 3) the foam filter 10, tube 3 and syringe 4 are inserted into a container containing liquid sample so that the distal end of the tube 3 is below the level of the liquid. The foam filter 10 is squeezed against the wall of the container to remove excess air. The syringe plunger is drawn back to the desired volume to draw liquid sample through the foam filter 10. When the correct amount of sample has been withdrawn, the foam filter 10 can be discarded prior to expulsion of the filtered sample.

In FIG. 4 an alternative embodiment of the invention is shown. A foam filter 20 is formed by die cutting. The foam filter 20 has the form of a cylindrical block of foam 21 with a partially removed central core 22. This removes the need to compress one end of an open ended cylinder as in the embodiment of FIG. 1.

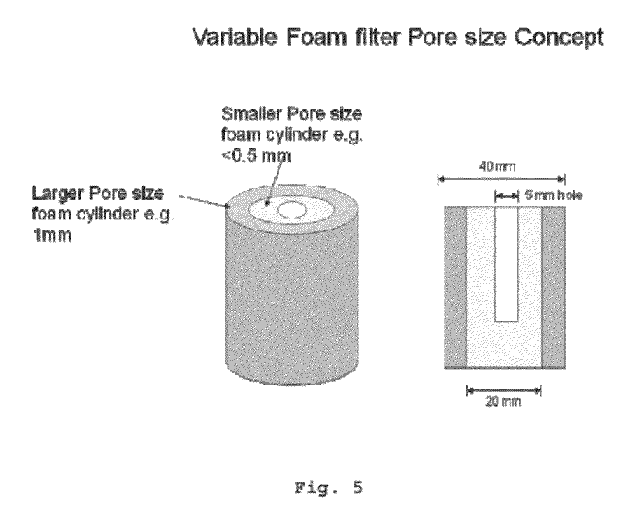

In FIG. 5 a further alternative embodiment of the invention is shown. A foam filter 30 has two parts: an inner part 31 and an outer part 33. The inner part 31 has the form of a cylindrical block of foam with a partially removed central core 32 (similar to foam filter 20 of FIG. 4). The outer part 33 has the form of a cylindrical tube and surrounds the inner part 31. The foam filter 30 has the following dimensions: 40 mm overall diameter, 20 mm diameter inner part, 5 mm diameter central core. The outer part 33 has a large pore size e.g. 1 mm. The inner part 31 has a small pore size e.g. less than 0.5 mm. In this way differential filtration can be achieved, with larger particles being trapped in the outer part 33 of the foam filter 30 and smaller particles passing through the outer part 33 but being trapped in the inner part 31.

### EXAMPLES

### Example 1

Two 375 g samples of raw ground beef were taken. Sample 1 was placed into a standard plastic Stomacher™ bag, and was hand mixed for 20 seconds, and then incubated with 500 ml of buffered peptone water at 42° C. for 5 hours. Sample 2 (comparative) was placed inside a filter within a Stomacher™ strainer bag and incubated under the same conditions as the first sample. For Sample 1 a foam filter, tube and syringe were prepared as shown in FIG. 2 and applied to the sample as shown in FIG. 3. A 10 ml sample was withdrawn using the syringe. The foam filter was removed by hand prior to expulsion of the sample and discarded inside the Stomacher™ bag. For Sample 2 a 10 ml sample was withdrawn using a standard 10 ml pipette.

The samples were allowed to settle and a comparison of the sample debris was made. Sample 1 had less debris than Sample 2 and provided a cleaner sample on subsequent analysis.

### Example 2

Two 25 g samples of faecal material were each re-suspended in 50 ml of phosphate buffered saline. For Sample 1 a foam filter, tube and syringe were prepared as shown in FIG. 2 and applied to the sample as shown in FIG. 3. A 10 ml sample was withdrawn using the syringe and the foam filter was removed prior to expulsion of the sample. For Sample 2 (comparative) a 10 ml sample was withdrawn using a standard 10 ml pipette (no filtration). The samples were allowed to settle and a comparison of the sample debris was made. Sample 1 had less debris than Sample 2 and provided a cleaner sample on subsequent analysis.

### Example 3

Two 10 g samples of soil were each re-suspended in 50 ml of phosphate buffered saline. For Sample 1 a foam filter, tube and syringe were prepared as shown in FIG. 2 and applied to the sample as shown in FIG. 3. A 10 ml sample was withdrawn using the syringe and the foam filter was removed prior to expulsion of the sample. For Sample 2 (comparative) a 10 ml sample was withdrawn using a standard 10 ml pipette. The samples were allowed to settle and a comparison of the sample debris was made. Sample 1 had less debris than Sample 2.

### Example 4

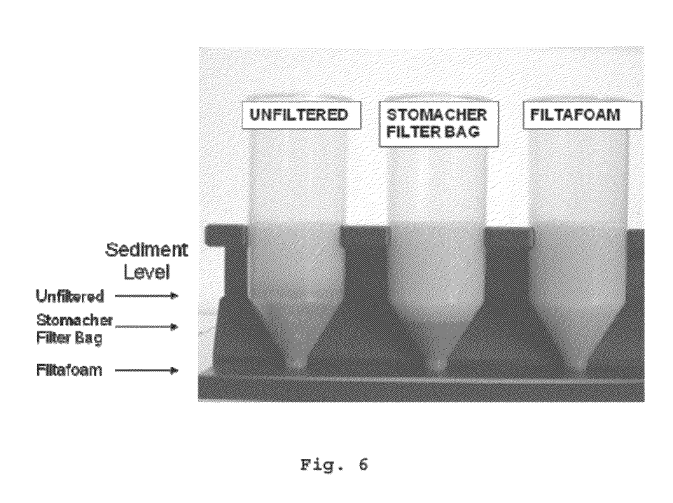

Three pet food samples were prepared. Sample 1 was filtered with a foam filter in accordance with the invention. Sample 2 (comparative) was filtered using a Stomacher™ strainer bag. Sample 3 was unfiltered. A photograph of the samples can be seen in FIG. 6. The sediment level is highest for Sample 3 (unfiltered), then for Sample 2 (filtered using Stomacher™ bag). No sediment can be seen in Sample 1 (foam filter).

The use of the foam filter considerably reduces the carryover of sample debris into the analytical methods that follow. The foam filter is simple and cost effective to use.

Whilst the invention has been described with reference to the illustrated preferred embodiments and Examples, it will be appreciated that various modifications are possible within the scope of the invention.

1. A sample preparation device comprising:
withdrawal means for withdrawing a sample from a liquid to be analysed; and
a foam filter for filtering particulate material from the sample as the sample is withdrawn, the foam filter being formed of a flexible foam and being mounted to the withdrawal means.

2. A sample preparation device as claimed in claim 1, wherein the foam filter is removably mounted to the withdrawal means via a friction fit.

3. A sample preparation device as claimed in claim 1 or claim 2, wherein the foam filter comprises a block of foam with a hole extending partway through the block of foam to enable a withdrawal means to be inserted.

4. A sample preparation device as claimed in claim 3, wherein the foam filter comprises a block of foam with a blind hole to enable a withdrawal means to be inserted.

5. A sample preparation device as claimed in claim 3, wherein the foam filter comprises a block of foam with a through hole having an end closed by means of compression and an opposite end open to enable a withdrawal means to be inserted.

6. A sample preparation device as claimed in any one of the preceding claims, wherein the foam filter is formed of foam having a pore size in the range of 0.2 μm to 10 mm.

7. A sample preparation device as claimed in any one of the preceding claims, wherein the foam filter comprises multiple layers with different pores sizes for differential filtration.

8. A foam filter formed of a flexible foam for use in a sample preparation device as claimed in any one of the preceding claims.

9. A method of preparing a sample from a liquid to be analysed, comprising:
withdrawing a sample from a liquid to be analysed using a sample preparation device as claimed in any one of claims 1 to 7 so that the foam filter filters particulate material present in the sample.

10. A method as claimed in claim 9, wherein the sample is withdrawn through the foam filter into the withdrawal means.

11. A method as claimed in claim 10, further comprising the steps of:
removing the foam filter from the withdrawal means;
and
dispensing the sample from the withdrawal means.
